(19) United States
(12) Patent Application Publication
(10) Pub. No.: US 2022/0052481 A1
(43) Pub. Date: Feb. 17, 2022

(54) MAGNETIC ELECTRIC CONNECTOR AND MAGNETIC TERMINAL THEREOF

(71) Applicants: Wen-Fu Pon, Dongguan (CN); John Wu, Dongguan (CN); Shang Sheng Cai, Dongguan (CN); Chun Shi, Dongguan (CN)

(72) Inventors: Wen-Fu Pon, Dongguan (CN); John Wu, Dongguan (CN); Shang Sheng Cai, Dongguan (CN); Chun Shi, Dongguan (CN)

(73) Assignee: Dongguan Yuqiu Electronic Co., Ltd

(21) Appl. No.: 16/991,046

(22) Filed: Aug. 12, 2020

(51) Int. Cl. H01R 13/62; H01R 11/30

(52) U.S. Cl. CPC H01R 13/6205; H01R 11/30

(57) ABSTRACT

A magnetic electric connector and its magnetic terminal. The magnetic electric connector comprises a male connector and a receptacle which are adapted to each other. The male connector comprises an insulator and several first magnetic terminals. The first magnetic terminal comprises a first magnet and a first metallic conducting layer fixed to the outer surface of the first magnet. The receptacle comprises a bench insulator and several second magnetic terminals. The second magnetic terminal comprises a second magnet and a second metallic conducting layer fixed to the outer surface of the second magnet. When the male connector and receptacle are butted, the first magnetic terminal of male connector is adsorbed on the second magnetic terminal of receptacle, forming electrical conduction, implementing charging or transmitting data, they can be localized and fastened without an additional fixing structure, guaranteeing a stable butting of male connector and receptacle.

### BACKGROUND OF INVENTION

### 1. Field of the Invention

The present invention relates generally to the domain of connector products, and more particularly to a magnetic electric connector and its magnetic terminal.

### 2. Description of Related Art

The main associated domains of electric connector include transportation, communication, network, IT, medical treatment, household appliances and military electronic products. The instant development of technical levels and rapid growth of the market of the products of associated domains strongly drag the development of connector technology. The electric connector has so far developed into a serialized and specialized product with complete product lines, abundant variety specifications, multiple structure types, specialized types, apparent industry features and normative standard system.

The charger used in such electronic products as intelligent wearable equipment and vehicle charged intelligent speakers is a sort of electric connector. The charger generally uses POGO PIN (i.e. spring ejector pin) to charge the equipment, and the POGO PIN (i.e. pogo pin) has high resistance, leading to low current and charging efficiency. In the charging process, the charging equipment must be placed on the charger upright, there is no suction-combining force between the charger and charging equipment, they are likely to get loose, inducing unstable charging process.

In view of this, this inventor proposes the following technical proposal.

### SUMMARY OF THE INVENTION

The purpose of the present invention is to overcome the shortcomings of the prior art and provide a magnetic electric connector and magnetic terminal thereof

In order to solve the above technical problems, the present invention adopts the following first technical solution:

A magnetic electric connector, which comprises a male connector and a receptacle which are adapted to each other, features:

said male connector comprises an insulator and several first magnetic terminals fixed into the insulator, the first magnetic terminal comprises a first magnet and a first metallic conducting layer fixed to the outer surface of the first magnet.

said receptacle comprises a bench insulator and several second magnetic terminals fixed into the bench insulator; the second magnetic terminal comprises a second magnet and a second metallic conducting layer fixed to the outer surface of the second magnet.

when said male connector and receptacle are butted, the first magnetic terminal of the male connector is adsorbed on the second magnetic terminal of receptacle, forming electrical conduction.

More particularly, the first metallic conducting layer is fixed to the outer surface of the first magnet by electroplating; the second metallic conducting layer is fixed to the outer surface of the second magnet by electroplating; the longitudinal cross-section of the first magnetic terminal is convex; the longitudinal cross-section of the second magnetic terminal is convex.

More particularly, an abutting slot is formed in the upper end of said bench insulator, the end face of the second magnetic terminal is exposed in the abutting slot; said insulator is provided with an abutting bulge adapted to the abutting slot; the end face of the first magnetic terminal is exposed in the end face of the abutting bulge.

More particularly, there are several first terminal slots in said insulator, and the end face of the abutting bulge is provided with a first window through the first terminal slot; the first magnetic terminal is put in the first terminal slot, and the end face of the first magnetic terminal is exposed in the end face of the abutting bulge through the first window; there are several second terminal slots in said bench insulator, and the bottom surface of the abutting slot is provided with a second window through the second terminal slot; the second magnetic terminal is put in the second terminal slot, and the end face of the second magnetic terminal is exposed in the bottom surface of the second terminal slot through the second window.

More particularly, said male connector comprises a first conducting element disposed in the insulator for connecting the circuit board or conductor and a first cover plate for fastening the first conducting element in the insulator, the first conducting element is electrically connected to the first magnetic terminal, the joint between the first cover plate and insulator is sealed with waterproof glue.

More particularly, said insulator is provided with a first locating slot, a first location column adapted to the first locating slot is formed on the first cover plate, the first location column is inserted in the first locating slot.

More particularly, wherein the first conducting element is a first metal spring tab, the front end of the first metal elastic piece is bent to form a first elastic guiding piece, and the first elastic guiding piece is in elastic contact with the first magnetic terminal and forms electrical conduction, and the end of the first metal spring tab extends out of the side of the insulator, the end of the first metal spring tab is soldered on the first conductor and conducted.

More particularly, The magnetic electric connector defined in claim 6, wherein the first conducting element is a first metal spring tab, the front end of the first metal spring tab is fixed to the first magnetic terminal by welding and forms electrical conduction, and the end of the first metal spring tab extends out of the side of the insulator, the end of the first metal spring tab is soldered on the first conductor and conducted.

More particularly, said receptacle comprises a second conducting element disposed in the bench insulator for connecting the circuit board or conductor and a second cover plate for fastening the second conducting element in the bench insulator, the second conducting element is electrically connected to the second magnetic terminal, the joint between the second cover plate and bench insulator is sealed with waterproof glue.

More particularly, said bench insulator is provided with a second locating slot, a second location column adapted to the second locating slot is formed on the second cover plate; the second location column is inserted in the second locating slot, and a second restraining groove is formed in the second cover plate; the second conducting element is put in the second restraining groove.

More particularly, wherein the second conducting element is a second metal spring tab, a front end of the second metal spring tab is bent to form a second elastic guiding piece, and the second elastic guiding piece is in elastic contact with the second magnetic terminal and forms electrical conduction, and the end of the second metal spring tab extends out of the side of the bench insulator, the end of the second metal spring tab is soldered on the second conductor and conducted.

More particularly, wherein the second conducting element is a second metal spring tab, the front end of the second metal spring tab is fixed to the second magnetic terminal by welding and forms electrical conduction, and the end of the second metal spring tab extends out of the side of the bench insulator, the end of the second metal spring tab is soldered on the second conductor and conducted.

More particularly, the magnetic terminal comprises a magnet and a metallic conducting layer fixed to the outer surface of the magnet for electric conduction.

More particularly, said metallic conducting layer is fixed to the outer surface of the magnet by electroplating.

More particularly, said metallic conducting layer covers the entire outer surface of magnet, and the metallic conducting layer has even thickness.

More particularly, the longitudinal cross-section of said magnetic terminal is convex.

More particularly, said magnet comprises a basal portion and an abutting portion integrated with the upper end of the basal portion; the size of the abutting portion is smaller than the size of basal portion; said metallic conducting layer covers the outer surface of basal portion and abutting portion.

More particularly, said basal portion and abutting portion are pancake-shaped.

More particularly, the shape of said basal portion and abutting portion is any one of rectangle, square, diamond, trapezoid and ellipse.

Compared with the prior art, the present invention has the following benefits:

1. The male connector and receptacle in the present invention use a magnetic terminal made by fixing a metallic conducting layer to the outer surface of magnet for conducting electricity or transmitting data. The magnetic terminal not only has the magnetic attraction power of magnet, but also implements the function of electric conduction or transmitting data through the metallic conducting layer, achieving dual effect. In addition, the low resistance of metallic conducting layer results in high current and high charging efficiency, implementing quick charge. When the male connector and receptacle are butted, the first magnetic terminal of the male connector is adsorbed on the second magnetic terminal of receptacle, forming electrical conduction, implementing charging or transmitting data, they can be localized and fastened without an additional fixing structure, guaranteeing the butting stability of male connector and receptacle. For the suction-combining force between the first magnetic terminal of male connector and the second magnetic terminal of receptacle, the male connector can be placed in the receptacle in multiple directions for charging, and there will not be loosening that induces unstable data transmission, guaranteeing the stability of charging or transmitting data. In addition, the male connector and receptacle of this structure can be butted forward or inversely and mixed, that is very convenient, giving the present invention strong marketability.

2. The magnetic terminal of the present invention not only has the magnetic attraction power of magnet, but also implements the function of electric conduction or transmitting data through the metallic conducting layer, achieving dual effect. Moreover, the low resistance of metallic conducting layer results in high current and high charging efficiency, implementing quick charge. The magnetic terminal in the present invention can be used as the terminal of charger in such electronic products as intelligent wearable equipment and vehicle charged intelligent speakers. When the charging equipment and charger are butted, for the suction-combining force of the magnetic terminal, the charging equipment can be put in the charger in multiple directions for charging without loosening, the stability of data transmission is protected, and the operation is very convenient, so that the present invention has very strong marketability.

### BRIEF DESCRIPTION OF THE DRAWINGS

FIG. 1 is an assembly drawing of magnetic electric connector in the present invention;

FIG. 2 is an exploded diagram of magnetic electric connector in the present invention;

FIG. 3 is a stereogram of receptacle in the present invention;

FIG. 4 is a three-dimensional exploded diagram of receptacle in the present invention;

FIG. 5 is a sectional view of the second magnetic terminal in the present invention;

FIG. 6 is an assembly drawing of the bench insulator and the second magnetic terminal in the present invention;

FIG. 7 is a stereogram of male connector in the present invention;

FIG. 8 is a three-dimensional exploded diagram of male connector in the present invention;

FIG. 9 is a sectional view of the first magnetic terminal in the present invention;

FIG. 10 shows an operating state of magnetic electric connector in the present invention;

FIG. 11 is an exploded diagram of magnetic electric connector in operating state in the present invention;

FIG. 12 is a stereogram of magnetic terminal in the present invention;

FIG. 13 is a sectional view of magnetic terminal in the present invention.

### DETAILED DESCRIPTION OF THE INVENTION

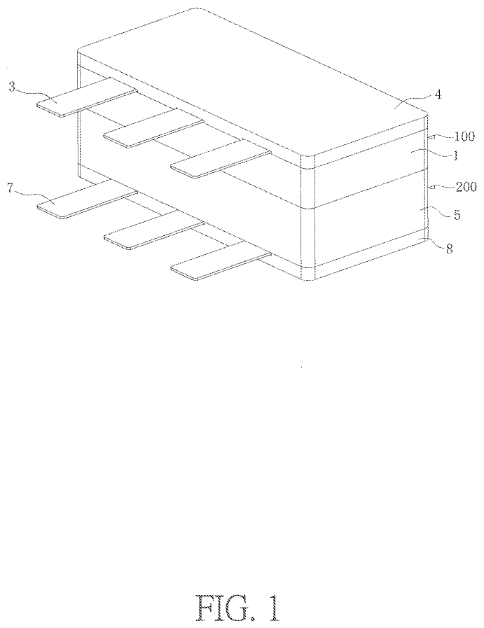

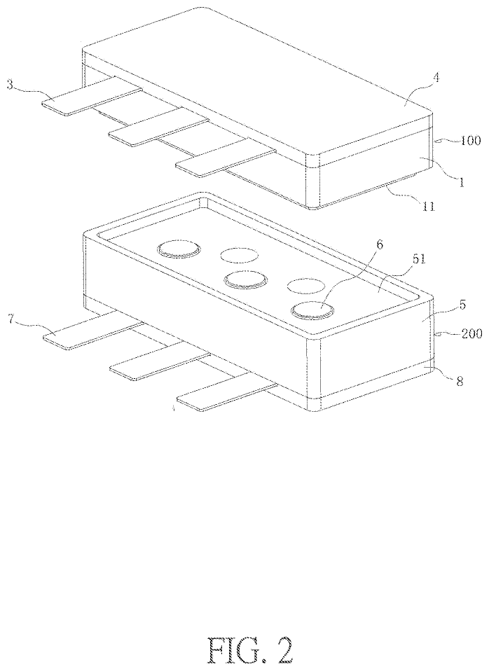

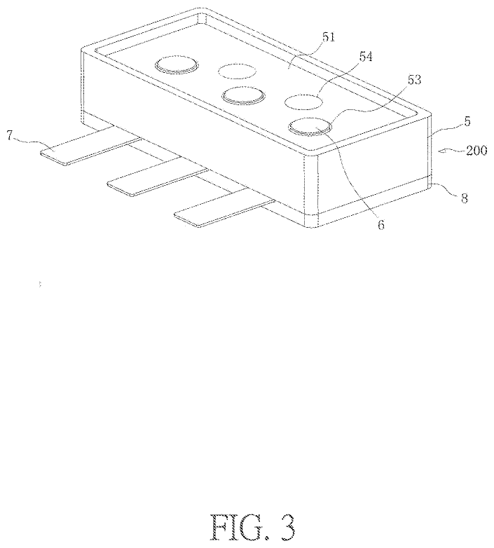

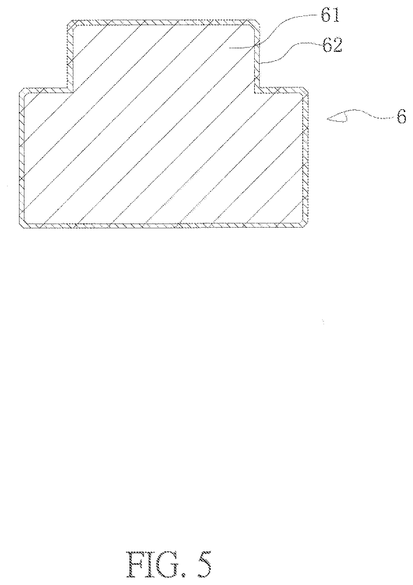

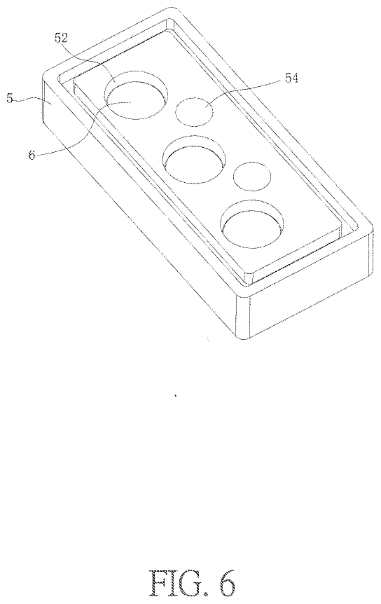

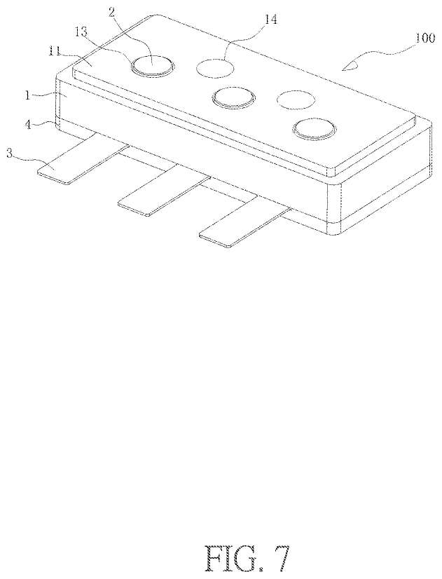

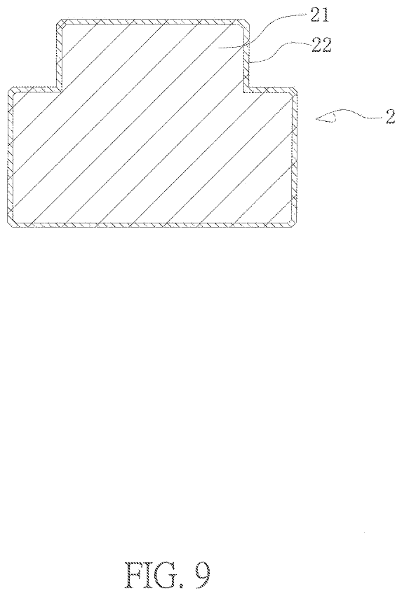

FIGS. 1-9 show a magnetic electric connector, the magnetic electric connector can be used as the charger of such electronic products as intelligent wearable equipment and vehicle charged intelligent speakers.

Said magnetic electric connector comprises a male connector 100 and a receptacle 200 which are adapted to each other. Said male connector 100 comprises an insulator 1 and several first magnetic terminals 2 fixed into the insulator 1. The first magnetic terminal 2 comprises a first magnet 21 and a first metallic conducting layer 22 fixed to the outer surface of the first magnet 21. Said receptacle 200 comprises a bench insulator 5 and several second magnetic terminals 6 fixed into the bench insulator 5. The second magnetic terminal 6 comprises a second magnet 61 and a second metallic conducting layer 62 fixed to the outer surface of the second magnet 61. When said male connector 100 and receptacle 200 are butted, the first magnetic terminal 2 of the male connector 100 is adsorbed on the second magnetic terminal 6 of receptacle 200, forming electrical conduction. The male connector 100 and receptacle 200 in the present invention use the magnetic terminal made by fixing a metallic conducting layer to the outer surface of magnet for conducting electricity or transmitting data, and the magnetic terminal not only has the magnetic attraction power of magnet, but also implements the function of electric conduction or transmitting data through the metallic conducting layer, achieving dual effect. Moreover, the low resistance of metallic conducting layer results in high current and high charging efficiency, implementing quick charge. When the male connector 100 and receptacle 200 are butted, the first magnetic terminal 2 of the male connector 100 is adsorbed on the second magnetic terminal 6 of receptacle 200, forming electrical conduction, implementing charging or transmitting data, they can be localized and fastened without additional fixing structures, guaranteeing the butting stability of male connector 100 and receptacle 200. For the suction-combining force between the first magnetic terminal 2 of male connector 100 and the second magnetic terminal 6 of receptacle 200, the male connector 100 can be placed in the receptacle 200 in multiple directions for charging, there will not be loosening which results in unstable data transmission, guaranteeing the stability of charging or transmitting data. In addition, the male connector 100 and receptacle 200 of this structure can be butted forward and inversely and mixed, that is very convenient, giving the present invention marketability.

The first metallic conducting layer 22 is fixed to the outer surface of the first magnet 21 by electroplating, and the first metallic conducting layer 22 wraps the entire outer surface of the first magnet 21. The second metallic conducting layer 62 is fixed to the outer surface of the second magnet 61 by electroplating, and the second metallic conducting layer 62 wraps the entire outer surface of the second magnet 61. The first magnetic terminal 2 and second magnetic terminal 6 of this structure can satisfy the perspiration test, guaranteeing the product quality.

An abutting slot 51 is formed in the upper end of said bench insulator 5. The end face of the second magnetic terminal 6 is exposed in the abutting slot 51. Said insulator 1 is provided with an abutting bulge 11 adapted to the abutting slot 51. The end face of the first magnetic terminal 2 is exposed in the end face of the abutting bulge 11. When said male connector 100 and receptacle 200 are butted, the abutting bulge 11 of insulator 1 is put in the abutting slot 51 in the upper end of bench insulator 5 for certain positioning, further preventing the loosening of male connector 100 and receptacle 200. At this point, the first magnetic terminal 2 is fixed to the second magnetic terminal 6 by magnetic attraction, forming electrical connection.

The longitudinal cross-section of the first magnetic terminal 2 is convex, the first magnetic terminal 2 of this shape can be assembled with insulator 1 better. Certainly, the longitudinal cross-section of the first magnetic terminal 2 can be other shapes, such as rectangle, trapezoid, circle and ellipse, it can be selected as required. The longitudinal cross-section of the second magnetic terminal 6 is convex, the second magnetic terminal 6 of this shape can be assembled with bench insulator 5 better. Certainly, the longitudinal cross-section of the second magnetic terminal 6 can be other shapes, such as rectangle, trapezoid, circle and ellipse, it can be selected as required.

There are several first terminal slots 12 in said insulator 1, and the end face of the abutting bulge 11 is provided with a first window 13 through the first terminal slot 12. The first magnetic terminal 2 is put in the first terminal slot 12. The end face of the first magnetic terminal 2 is exposed on the end face of the abutting bulge 11 through the first window 13, even with the end face of abutting bulge 11, the assembly structure is very simple.

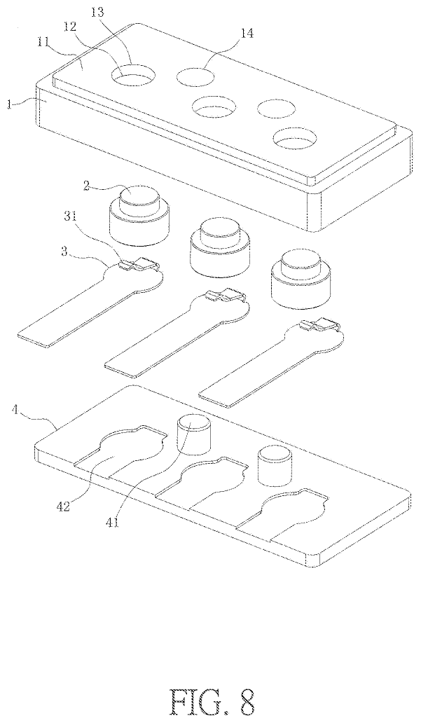

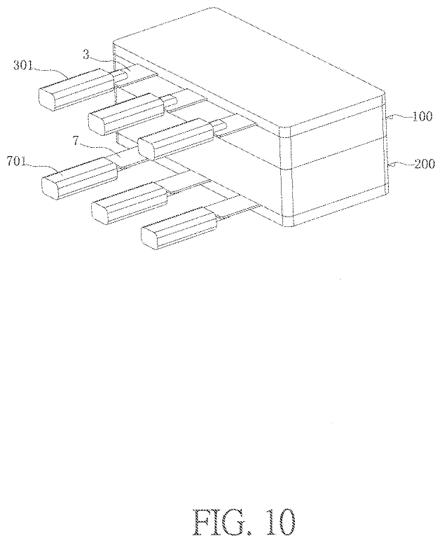

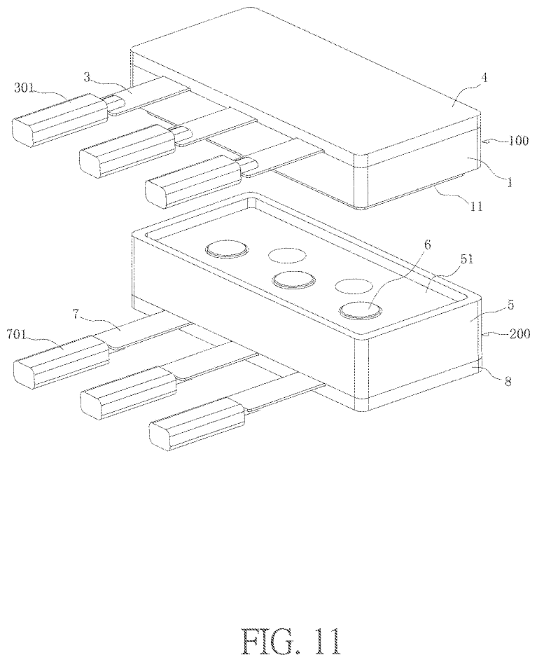

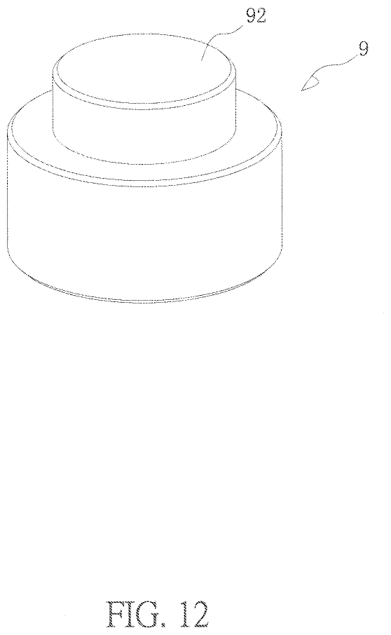

Said male connector 100 comprises a first conducting element 3 disposed in the insulator 1 for connecting the circuit board or conductor and a first cover plate 4 for fastening the first conducting element 3 in the insulator 1. The first conducting element 3 is electrically connected to the first magnetic terminal 2. The joint of the first cover plate 4 and insulator 1 is sealed with waterproof glue, so that the whole male connector 100 has good waterproof effect. Secondly, as shown in FIG. 8, the first conducting element 3 is a first metal spring tab, wherein the front end of the first metal elastic piece is bent to form a first elastic guiding piece, and the first elastic guiding piece is in elastic contact with the first magnetic terminal and forms electrical conduction; with reference to FIGS. 10-11, the end of the first metal spring tab extends out of the side of the insulator 1, the end of the first metal spring tab is soldered on the first conductor 301 and conducted, the other end of the first conductor 301 can be connected to an external equipment through TYPE C or USB interface, so as to implement charging and/or transmitting data. Or, in another embodiment, wherein the first conducting element 3 is a first metal spring tab, the front end of the first metal spring tab is fixed to the first magnetic terminal 2 by welding and forms electrical conduction as shown in FIG. 12, and the end of the first metal spring tab extends out of the side of the insulator, the end of the first metal spring tab is soldered on the first conductor 301 and conducted. The other end of the first conductor 301 can be connected to an external device through a TYPE C or USB interface to realize charging and/or data transmission.

Said insulator 1 is provided with a first locating slot 14. A first location column 41 adapted to the first locating slot 14 is formed on the first cover plate 4. The first location column 41 is inserted in the first locating slot 14, and a first restraining groove 42 is formed in the first cover plate 4. The first conducting element 3 is put in the first restraining groove 42, so as to guarantee a stable assembly structure of the overall male connector 100 to enhance the communication quality of male connector 100.

There are several second terminal slots 52 in said bench insulator 5, and the bottom surface of the abutting slot 51 is provided with a second window 53 through the second terminal slot 52. The second magnetic terminal 6 is put in the second terminal slot 52. The end face of the second magnetic terminal 6 is exposed in the bottom surface of the second terminal slot 52 through the second window 53, even with the bottom surface of the second terminal slot 52, the assembly structure is very simple.

Said receptacle 200 comprises a second conducting element 7 disposed in the bench insulator 5 for connecting the circuit board or conductor and a second cover plate 8 for fastening the second conducting element 7 in the bench insulator 5. The second conducting element 7 is electrically connected to the second magnetic terminal 6, and the joint between the second cover plate 8 and bench insulator 5 is sealed with waterproof glue, so that the entire receptacle 200 has good waterproof effect.

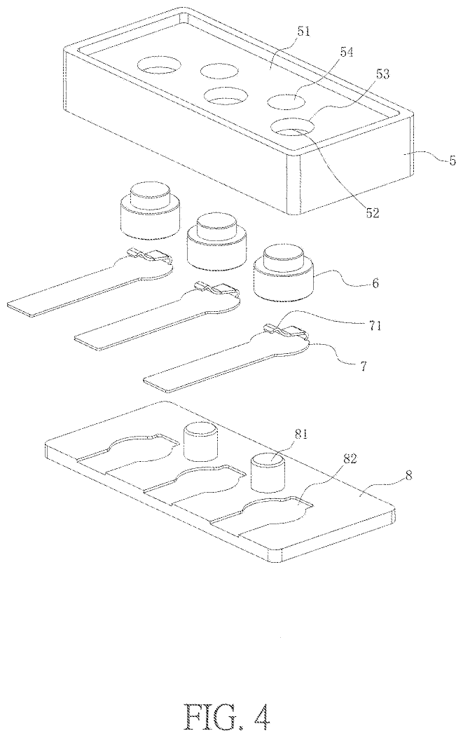

As shown in FIG. 4, the second conducting element 7 is a second metal spring tab, wherein a front end of the second metal spring tab is bent to form a second elastic guiding piece 71, and the second elastic guiding piece 71 is in elastic contact with the second magnetic terminal 6 and forms electrical conduction, and the end of the second metal spring tab extends out of the side of the bench insulator 5, the end of the second metal spring tab is soldered on the second conductor 701 and conducted, the other end of the second conductor 701 can be connected to an external equipment through TYPE C or USB interface, so as to implement charging and/or transmitting data. Or, another embodiment is that the second conducting element 7 is a second metal spring tab, the front end of the second metal spring tab is fixed to the second magnetic terminal 6 by welding and forms electrical conduction, and the end of the second metal spring tab extends out of the side of the bench insulator, the end of the second metal spring tab is soldered on the second conductor 701 and conducted. The other end of the first conductor 701 can be connected to an external device through a TYPE C or USB interface to realize charging and/or data transmission. Said bench insulator 5 is provided with a second locating slot 54, a second location column 81 adapted to the second locating slot 54 is formed on the second cover plate 8. The second location column 81 is inserted in the second locating slot 54. A second restraining groove 82 is formed in the second cover plate 8. The second conducting element 7 is put in the second restraining groove 82, so as to guarantee a stable assembly structure of the entire receptacle 200 to upgrade the communication quality of receptacle 200.

To sum up, the male connector 100 and receptacle 200 in the present invention use a magnetic terminal made by fixing a metallic conducting layer to the outer surface of magnet for conducting electricity or transmitting data. The magnetic terminal not only has the magnetic attraction power of magnet, but also implements the function of electric conduction or transmitting data through the metallic conducting layer, achieving dual effect. In addition, the low resistance of metallic conducting layer results in high current and high charging efficiency, implementing quick charge. When the male connector 100 and receptacle 200 are butted, the first magnetic terminal 2 of the male connector 100 is adsorbed on the second magnetic terminal 6 of receptacle 200, forming electrical conduction, implementing charging or transmitting data, they can be localized and fastened without an additional fixing structure, guaranteeing the butting stability of male connector 100 and receptacle 200. For the suction-combining force between the first magnetic terminal 2 of male connector 100 and the second magnetic terminal 6 of receptacle 200, the male connector 100 can be placed in the receptacle 200 in multiple directions for charging, and there will not be loosening that induces unstable data transmission, guaranteeing the stability of charging or transmitting data. In addition, the male connector 100 and receptacle 200 of this structure can be butted forward or inversely and mixed, that is very convenient, giving the present invention strong marketability.

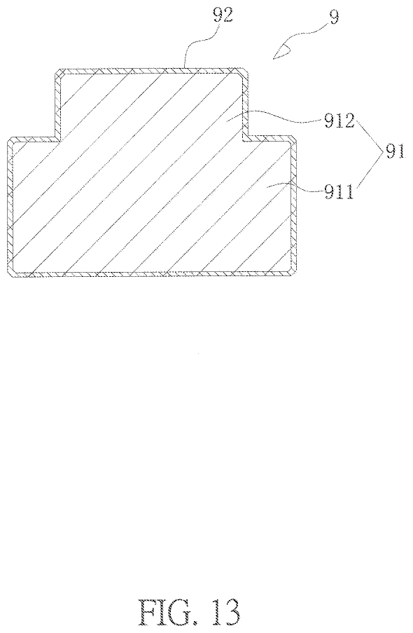

FIGS. 12-13 show a magnetic terminal applied to said magnetic electric connector. The magnetic terminal 9 comprises a magnet 91 and a metallic conducting layer 92 fixed to the outer surface of the magnet 91. The magnetic terminal 9 of the present invention not only has the magnetic attraction power of magnet, but also implements the function of electric conduction or transmitting data through the metallic conducting layer, achieving dual effect. Moreover, the low resistance of metallic conducting layer results in high current and high charging efficiency, implementing quick charge. The magnetic terminal in the present invention can be used as the terminal of charger in such electronic products as intelligent wearable equipment and vehicle charged intelligent speakers. When the charging equipment and charger are butted, for the suction-combining force of the magnetic terminal 9, the charging equipment can be put in the charger in multiple directions for charging without loosening, the stability of data transmission is protected, and the operation is very convenient, so that the present invention has very strong marketability.

Said metallic conducting layer 92 is fixed to the outer surface of the magnet 91 by electroplating, so that the metallic conducting layer 92 can be firmly fixed to the outer surface of the magnet 91, the structure is very firm, the magnetic terminal 9 of this structure can satisfy the perspiration test, guaranteeing the product quality.

Said metallic conducting layer 92 covers the whole outer surface of magnet 91, and the metallic conducting layer 92 has even thickness.

The longitudinal cross-section of said magnetic terminal is convex, the magnetic terminal 9 of this shape can be assembled with insulator better. To be specific, said magnet 91 comprises a basal portion 911 and an abutting portion 912 integrated with the upper end of the basal portion 911. The size of the abutting portion 912 is smaller than the size of basal portion 911. Said metallic conducting layer 92 covers the outer surface of basal portion 911 and abutting portion 912.

Said basal portion 911 and abutting portion 912 are pancake-shaped. Alternatively, the shape of said basal portion 911 and abutting portion 912 is any one of rectangle, square, diamond, trapezoid and ellipse.

To sum up, the magnetic terminal 9 of the present invention not only has the magnetic attraction power of magnet, but also implements the function of electric conduction or transmitting data through the metallic conducting layer, achieving dual effect. Moreover, the low resistance of metallic conducting layer results in high current and high charging efficiency, implementing quick charge. The magnetic terminal in the present invention can be used as the terminal of charger in such electronic products as intelligent wearable equipment and vehicle charged intelligent speakers. When the charging equipment and charger are butted, for the suction-combining force of the magnetic terminal 9, the charging equipment can be put in the charger in multiple directions for charging without loosening, the stability of data transmission is protected, and the operation is very convenient, so that the present invention has very strong marketability.

The magnetic terminal of the present invention not only has the magnetic attraction power of magnet, but also implements the function of electric conduction or transmitting data through the metallic conducting layer, achieving dual effect. Moreover, the low resistance of metallic conducting layer results in high current and high charging efficiency, implementing quick charge. The magnetic terminal in the present invention can be used as the terminal of charger in such electronic products as intelligent wearable equipment and vehicle charged intelligent speakers. When the charging equipment and charger are butted, for the suction-combining force of the magnetic terminal, the charging equipment can be put in the charger in multiple directions for charging without loosening, the stability of data transmission is protected, and the operation is very convenient, so that the present invention has very strong marketability.

We claim:

1. A magnetic electric connector, which comprises a male connector and a receptacle which are adapted to each other, features:
said male connector comprises an insulator and several first magnetic terminals fixed into the insulator, the first magnetic terminal comprises a first magnet and a first metallic conducting layer fixed to the outer surface of the first magnet;
said receptacle comprises a bench insulator and several second magnetic terminals fixed into the bench insulator; the second magnetic terminal comprises a second magnet and a second metallic conducting layer fixed to the outer surface of the second magnet;
when said male connector and receptacle are butted, the first magnetic terminal of the male connector is adsorbed on the second magnetic terminal of receptacle, forming electrical conduction.

2. The magnetic electric connector defined in claim 1, the first metallic conducting layer is fixed to the outer surface of the first magnet by electroplating; the second metallic conducting layer is fixed to the outer surface of the second magnet by electroplating; the longitudinal cross-section of the first magnetic terminal is convex; the longitudinal cross-section of the second magnetic terminal is convex.

3. The magnetic electric connector defined in claim 1, an abutting slot is formed in the upper end of said bench insulator, the end face of the second magnetic terminal is exposed in the abutting slot; said insulator is provided with an abutting bulge adapted to the abutting slot; the end face of the first magnetic terminal is exposed in the end face of the abutting bulge.

4. The magnetic electric connector defined in claim 3, there are several first terminal slots in said insulator, and the end face of the abutting bulge is provided with a first window through the first terminal slot; the first magnetic terminal is put in the first terminal slot, and the end face of the first magnetic terminal is exposed in the end face of the abutting bulge through the first window; there are several second terminal slots in said bench insulator, and the bottom surface of the abutting slot is provided with a second window through the second terminal slot; the second magnetic terminal is put in the second terminal slot, and the end face of the second magnetic terminal is exposed in the bottom surface of the second terminal slot through the second window.

5. The magnetic electric connector defined in claim 1, said male connector comprises a first conducting element disposed in the insulator for connecting the circuit board or conductor and a first cover plate for fastening the first conducting element in the insulator, the first conducting element is electrically connected to the first magnetic terminal, the joint between the first cover plate and insulator is sealed with waterproof glue.

6. The magnetic electric connector defined in claim 5, said insulator is provided with a first locating slot, a first location column adapted to the first locating slot is formed on the first cover plate, the first location column is inserted in the first locating slot.

7. The magnetic electric connector defined in claim 6, wherein the first conducting element is a first metal spring tab, the front end of the first metal elastic piece is bent to form a first elastic guiding piece, and the first elastic guiding piece is in elastic contact with the first magnetic terminal and forms electrical conduction, and the end of the first metal spring tab extends out of the side of the insulator, the end of the first metal spring tab is soldered on the first conductor and conducted.

8. The magnetic electric connector defined in claim 6, wherein the first conducting element is a first metal spring tab, the front end of the first metal spring tab is fixed to the first magnetic terminal by welding and forms electrical conduction, and the end of the first metal spring tab extends out of the side of the insulator, the end of the first metal spring tab is soldered on the first conductor and conducted.

9. The magnetic electric connector defined in claim 1, said receptacle comprises a second conducting element disposed in the bench insulator for connecting the circuit board or conductor and a second cover plate for fastening the second conducting element in the bench insulator, the second conducting element is electrically connected to the second magnetic terminal, the joint between the second cover plate and bench insulator is sealed with waterproof glue.

10. The magnetic electric connector defined in claim 8, said bench insulator is provided with a second locating slot, a second location column adapted to the second locating slot is formed on the second cover plate; the second location column is inserted in the second locating slot, and a second restraining groove is formed in the second cover plate; the second conducting element is put in the second restraining groove.

11. The magnetic electric connector defined in claim 9, wherein the second conducting element is a second metal spring tab, a front end of the second metal spring tab is bent to form a second elastic guiding piece, and the second elastic guiding piece is in elastic contact with the second magnetic terminal and forms electrical conduction, and the end of the second metal spring tab extends out of the side of the bench insulator, the end of the second metal spring tab is soldered on the second conductor and conducted.

12. agnetic electric connector defined in claim 9, wherein the second conducting element is a second metal spring tab, the front end of the second metal spring tab is fixed to the second magnetic terminal by welding and forms electrical conduction, and the end of the second metal spring tab extends out of the side of the bench insulator, the end of the second metal spring tab is soldered on the second conductor and conducted.

13. A magnetic terminal of the magnetic electric connector stated in claim 1, features: the magnetic terminal comprises a magnet and a metallic conducting layer fixed to the outer surface of the magnet for electric conduction.

14. The magnetic terminal of the magnetic electric connector defined in claim 11, said metallic conducting layer is fixed to the outer surface of the magnet by electroplating.

15. The magnetic terminal of the magnetic electric connector defined in claim 12, said metallic conducting layer covers the entire outer surface of magnet, and the metallic conducting layer has even thickness.

16. The magnetic terminal of the magnetic electric connector defined in claim 11, the longitudinal cross-section of said magnetic terminal is convex.

17. The magnetic terminal of the magnetic electric connector defined in claim 14, said magnet comprises a basal portion and an abutting portion integrated with the upper end of the basal portion; the size of the abutting portion is smaller than the size of basal portion; said metallic conducting layer covers the outer surface of basal portion and abutting portion.

18. The magnetic terminal of the magnetic electric connector defined in claim 15, said basal portion and abutting portion are pancake-shaped.

19. The magnetic terminal of the magnetic electric connector defined in claim 15, the shape of said basal portion and abutting portion is any one of rectangle, square, diamond, trapezoid and ellipse.
